(19) United States
(12) Patent Application Publication
(10) Pub. No.: US 2012/0300662 A1
(43) Pub. Date: Nov. 29, 2012

(54) Cellular Control Sensing for Multicell Device-to-Device Interference Control

(75) Inventors: Haiming Wang, Beijing (CN); Tao Chen, Oulu (FI); Tao Peng, Beijing (CN)

(73) Assignee: Nokia Corporation, Espoo (FI)

(21) Appl. No.: 13/574,561

(22) PCT Filed: Jan. 22, 2010
(86) PCT No.: PCT/CN10/70327

§ 371 Date: Jul. 20, 2012

(51) Int. Cl. H04W 72/04; H04W 24/00

(52) U.S. Cl. 370/252; 370/329

(57) ABSTRACT

A method, apparatus, computer readable medium is provided to perform resource coordination among multiple cells to cancel near-far interference for device-to-device transmission, including cross-cell device-to-device transmission. In this context, a dedicated resource exchanging channel can be defined between cellular user equipment and device-to-device user equipment for interference control and resource coordination. A cellular user equipment can forward its uplink resource grant information over the dedicated resource exchanging channel when it determines potential interference. A device-to-device user equipment can monitor the dedicated resource exchanging channel in order to identify one or more resources that can potentially interfere with device-to-device transmission.

### BACKGROUND

1. Field

Certain embodiments relate generally to communication systems, and more particularly, to a direct device-to-device (D2D) communication integrated into a cellular network, such as a long-term evolution (LTE) or long-term evolution advanced (LTE-A) cellular network specified by the 3rd Generation Partnership Project (3GPP).

2. Description of the Related Art

Two types of communication networks are cellular networks and ad-hoc networks. A cellular network is a radio network made up of one or more cells, where each cell is served by at least one centralized controller, such as a base station (BS), a Node B, or an evolved Node B (eNB). In a cellular network, a user equipment (UE) communicates with another UE via the centralized controller, where the centralized controller relays messages sent by a first UE to a second UE, and visa-versa. In contrast, in an ad-hoc network, a UE directly communicates with another UE, without the need of a centralized controller. Utilizing a cellular network versus an ad-hoc network has its benefits and drawbacks. For example, utilizing a cellular network over an ad-hoc network provides the benefit of easy resource control and interference control. However, utilizing a cellular network over an ad-hoc network also provides the drawback of inefficient resource utilization. In other words, double resources will be required in a cellular network when the two UEs are close to each other, as compared to an ad-hoc network.

Furthermore, two types of D2D operation are cellular-controlled D2D and autonomous D2D. In cellular-controlled D2D, a BS is responsible for a channel access of D2D operation via scheduling in a tight coupling mode. In autonomous D2D, a channel access scheme such as a request-to-send (RTS)/clear-to-send (CTS) supplemented Carrier Sensing Multiple Access/Collision Avoidance (CSMA/CA) is applied with a loose coupling with an underlying cellular system. If a node has a packet to send, it first transmits a RTS packet to request the channel. If available, the receiver replies with a CTS packet. After the sender receives the CTS packet successfully, it proceeds to transmit the actual data packet. Other nodes that hear the RTS packet will defer transmission for a sufficiently long period of time to allow the transmitting node to receive the CTS packet. Other nodes that hear the CTS packet will back off for a period of time that is sufficiently long to allow the receiving node to receive the entire data packet. This is known as an IEEE 802.11 RTS/CTS mechanism.

In order to help optimize system throughput, a hybrid network utilizes both a cellular mode and a D2D transmission mode. In a hybrid network, a UE can choose to communicate either via a cellular mode or a D2D transmission mode. As an example, a hybrid network may allow UEs to communicate either via a cellular mode (i.e. via a centralized controller) or via an autonomous D2D transmission mode where the UEs can establish a channel without the need for a centralized controller. The UE can make this selection depending on which mode provides better overall performance. Thus, a hybrid network can improve total system performance over a cellular network or an ad-hoc network. However, in order to utilize a hybrid network, specifically a hybrid network which implements an autonomous D2D transmission mode, problems of such a hybrid network, such as resource sharing and interference situations, should be addressed.

### SUMMARY

According to an embodiment of the invention, a method includes defining a dedicated resource exchanging channel. The method further includes broadcasting a resource of a common control channel. The dedicated resource exchanging channel is used to relay resource information used to perform interference sensing.

According to another embodiment, a method includes determining a potential interference to a device-to-device user equipment. The method further includes transmitting resource information over a dedicated resource exchanging channel. The resource information is used to perform interference sensing.

According to another embodiment, a method includes receiving resource information over a dedicated resource exchange channel. The method further includes selecting a resource using the received resource information. The method further includes transmitting the selected resource. The resource information is used to perform interference sensing.

According to another embodiment, an apparatus includes a processor, and a memory including computer program code. The memory and the computer program code are configured to, with the processor, cause the apparatus to define a dedicated resource exchanging channel, and broadcast a resource of a common control channel. The dedicated resource exchanging channel is used to relay resource information used to perform interference sensing.

According to another embodiment, an apparatus includes a processor, and a memory including computer program code. The memory and the computer program code are configured to, with the processor, cause the apparatus to determine a potential interference to a device-to-device user equipment, and transmit resource information over a dedicated resource exchanging channel. The resource information is used to perform interference sensing.

According to another embodiment, an apparatus includes a processor, and a memory including computer program code. The memory and the computer program code are configured to, with the processor, cause the apparatus to receive resource information over a dedicated resource exchange channel, select a resource using the received resource information, and transmit the selected resource. The resource information is used to perform interference sensing.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates an example of a communication system, according to one embodiment.

FIG. 2 illustrates a signaling flow for a method of control sensing and device-to-device resource coordination according to one embodiment.

FIG. 3 illustrates a timing diagram for a method of control sensing and device-to-device resource coordination according to one embodiment.

FIG. 4 illustrates a method according to one embodiment.

FIG. 5 illustrates a method according to another embodiment.

FIG. 6 illustrates a method according to another embodiment.

FIG. 7 illustrates an apparatus according to one embodiment.

FIG. 8 illustrates an apparatus according to another embodiment.

FIG. 9 illustrates an apparatus according to another embodiment.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

As described above, a hybrid network that utilizes both a cellular mode and an autonomous D2D transmission mode can present resource sharing and interference problems. More specifically, since UEs that communicate via the cellular mode can share the same frequency resources with UEs that communicate via the autonomous D2D transmission mode, cellular UEs can generate interference for D2D UEs, and visa-versa. This interference is known as near-far interference. Furthermore, in a hybrid network which includes a plurality of cells, near-far interference can take one of two forms: intra-cell interference, and inter-cell interference. Intra-cell interference is where the source of the interference for a pair of UEs is within the cell of the sending UE, is within the cell of the receiving UE, or both. Inter-cell interference is where the source of the interference for a pair of UEs is not within the cell of either the sending UE or the receiving UE. Such interference is very difficult to control for cross-cell D2D UEs (where the sending D2D UE is at an edge of a first cell, and where the receiving D2D UE is at an edge of a second cell), especially when the near-far interference is from another cell which is near both the cell of the sending D2D UE, and the receiving D2D UE.

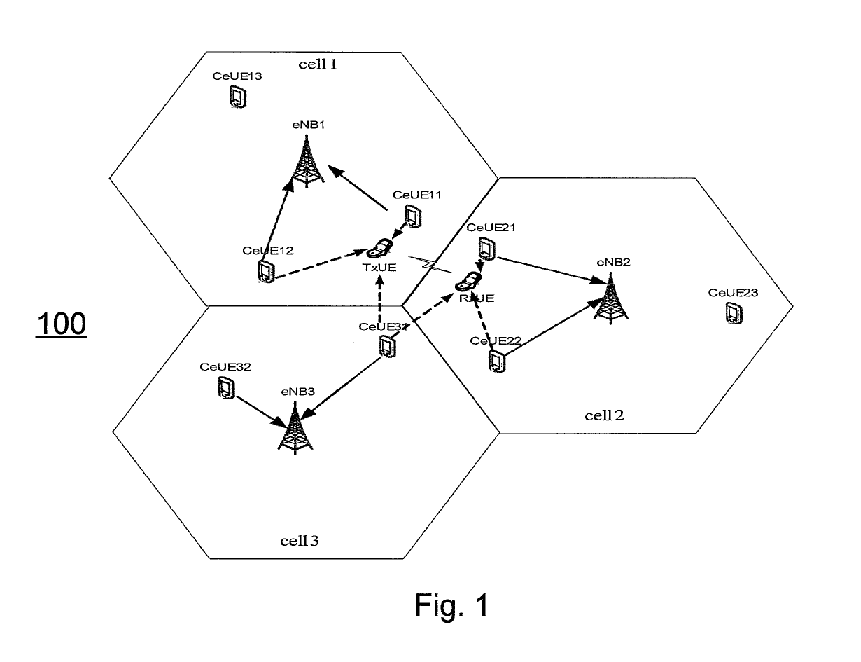

An example of a problem of near-far interference is further described in relation to FIG. 1, which illustrates an example of a communication system 100 according to one embodiment. In the embodiment, system 100 includes three cells, cell 1, cell 2, and cell 3. However, as one of ordinary skill would readily appreciate, system 100 can include any number of cells. System 100 also includes three eNBs, eNB1, eNB2, and eNB3. eNB1 is located in cell 1, eNB2 is located in cell 2, and eNB3 is located in cell 3. However, system 100 can include any number of eNBs, with any number of eNBs being within a given cell. System 100 also includes cellular UEs CeUE11, CeUE12, CeUE13, CeUE21, CeUE22, CeUE23, CeUE31, and CeUE32. CeUE11, CeUE12, CeUE13 are each located in cell 1, CUE21, CeUE22, and CeUE23 are each located in cell 2, and CeUE31 and CeUE32 are each located in cell 3. System 100 also includes D2D UEs TxUE and RxUE. TxUE is located in cell 1, near the edge between cell 1 and cell 2, and RxUE is located in cell 2, also near the edge between cell 1 and cell 2. However, system 100 can include any number of cellular UEs and D2D UEs, with any number of cellular UEs and D2D UEs being within a given cell.

In cell 1 of system 100, CeUE11 and CeUE12 can impose interference on TxUE due to their close proximity to TxUE. Likewise, in cell 2 of system 100, CeUE21 and CeUE22 can impose interference on RxUE due to their close proximity to RxUE. Furthermore, in cell 3 of system 100, CeUE31 can impose interference on both TxUE and RxUE because of its close proximity to both TxUE and RxUE. The interference from CeUE11, CeUE12, CeUE21, and CeUE22 is intra-cell interference because the source of the interference (i.e., CeUE11, CeUE12, CeUE21, and CeUE22) is within the same cell as the target of the interference (i.e., TxUE and RxUE), respectively. The interference from CeUE31 is inter-cell interference because the source of the interference (i.e., CeUE31) is not within the same cell as the target of the interference (i.e., TxUE and RxUE).

Intra-cell interference can be effectively avoided by using smart interference measurements. However, inter-cell interference is extremely difficult to avoid for many reasons. First, in most 3rd Generation (3G) and Beyond 3rd Generation (B3G) systems, a BS (or NodeB or eNB) allocates the frequency resource to cellular UEs in a dynamic way, which means that D2D UEs can not predicate the resource allocation accurately according to the accumulated knowledge of the D2D UE. Thus, a D2D UE cannot effectively predict which cellular resource is most likely to generate interference and avoid that resource based on previous resource allocation by the BS. Second, inter-cell interference is generated from a frequency resource that is unknown to the D2D UEs because the source of the interference is located in a different cell from the D2D UEs. Therefore, a D2D UE can not effectively predicate or control the nature of the inter-cell interference.

According to an embodiment, a solution is provided to perform resource coordination among multiple cells of a communication system, such as system 100 of FIG. 1, to prevent inter-cell interference for cross-cell D2D transmission. The solution can determine potential interferers and avoid them so that the inter-cell interference that would be generated by the potential interferers can be avoided. Thus, according to an embodiment, D2D UEs can autonomously decide which resources should be prohibited to avoid inter-cell interference from a cellular UE.

Potential interference is a scenario where a first end user (such as a UE) shares one or more resources with a second end user, and where a transmission power of the transmission by a first end user exceeds a pre-defined threshold, and thus, can interfere with the transmission of the second end user. In this scenario, the first end user “potentially interferes” with the second end user, and the first user is identified as a “potential interferer.”

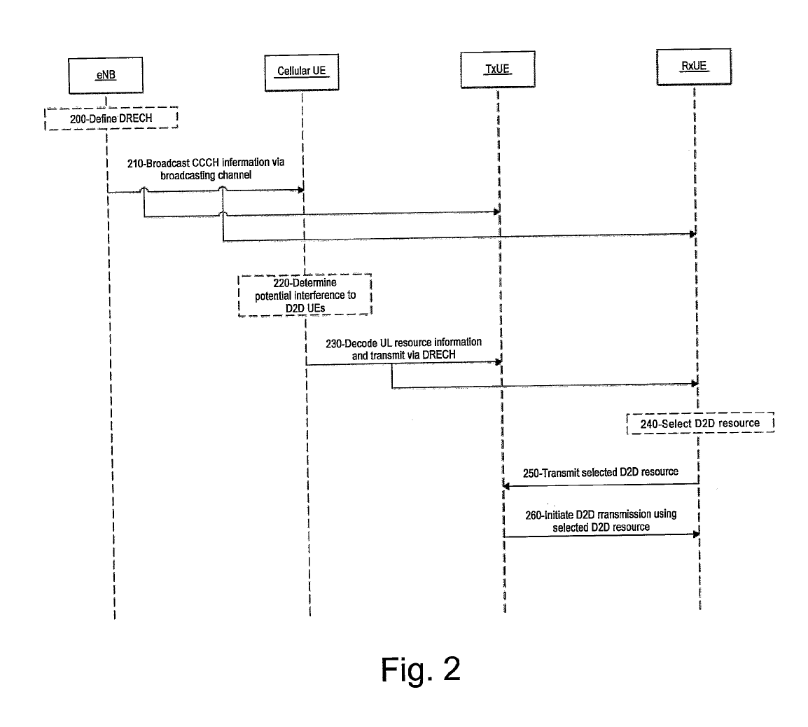

FIG. 2 illustrates a signaling flow for a method of control sensing and device-to-device resource coordination in order to prevent inter-cell interference according to one embodiment. The signaling flow illustrated in FIG. 2 includes a signaling flow for an eNB, a cellular UE, a transmitting D2D UE (identified as TxUE in FIG. 2), and a receiving D2D UE (identified as RxUE in FIG. 2). In an embodiment, the eNB in FIG. 2 corresponds to the eNBs in system 100 of FIG. 1, the cellular UE in FIG. 2 corresponds to the cellular UEs in system 100 of FIG. 1, and TxUE and RxUE of FIG. 2 each correspond to the transmitting D2D UEs and receiving D2D UEs in system 100 of FIG. 1, respectively.

According to an embodiment, at 200, an eNB defines a dedicated resource exchanging channel (DRECH) between cellular UEs in a communication system and D2D UEs also in a communication system. A DRECH can provide information regarding one or more resources that are dedicated for cellular communication between one or more cellular UEs and the eNB. As will be described below in more detail, the DRECH can be used by cellular UEs to transmit resource information to D2D UEs, in order that the D2D UEs can identify resources that can be used for cellular communication, and so that the D2D UEs can perform interference sensing of the cellular UEs.

The eNB can assign one or more dedicated resources for the DRECH. These one or more dedicated resources can be used by cellular UEs to communicate resource information to D2D UEs. For example, the one or more dedicated resources can include a time domain, a frequency domain, a code domain, or any combination of the domains. Thus, in an embodiment, the eNB notifies cellular UEs and D2D UEs of the one or more dedicated resources used by the DRECH, so that the one or more dedicated resources are known by the cellular UEs and the D2D UEs in advance, and so that the cellular UEs can use the one or more dedicated resources to communicate resource information to D2D UEs. As an example, the eNB can notify the cellular UEs and the D2D UEs of the dedicated resources of the DRECH. For effective interaction via DRECH, the used resources for DRECH are known in advance among all the interested cells via an X2 interface.

In an embodiment, the dedicated resources are located in a cellular uplink (UL) spectrum. In telecommunication, a communications link is used to connect one location to another for purposes of transmitting and receiving information. A UL is the portion of a communications link used for the transmission of information from a UE to a centralized controller (such as a BS, NodeB, or eNB). In contrast, a downlink (DL) is the portion of the communications link used for the transmission of information from the centralized controller to the UE.

In the embodiment, the dedicated resources are located in the UL spectrum because the DRECH can be used by cellular UEs to transmit information to a centralized controller, which in turn transmits the information to D2D UEs, as will be described below in more detail. Also in an embodiment, the dedicated resources can not be used for data transmission by cell-edge cellular UEs, although then can be re-used by central cellular UEs.

At 210, according to the embodiment, the eNB broadcasts a dedicated resource of a D2D common control channel (CCCH) via a broadcasting channel. A CCCH is a channel that can be used by a pair of D2D UEs, as part of a CSMA/CA media access control (MAC) protocol for D2D transmission, to claim one or more dedicated resources in a contentious way using a RTS/CTS based mechanism. As previously described, in a RTS/CTS based mechanism, a transmitting D2D UE sends an RTS message to a receiving D2D UE indicating that it intends to communicate with the receiving D2D UE. In response, the receiving D2D UE sends a CTS message to the transmitting D2D UE, indicating that it is acceptable for the transmitting D2D UE to start transmitting data to the receiving D2D UE. Thus, according to the embodiment, a pair of D2D UEs can utilize a D2D CCCH to perform a handshaking procedure using a CSMA/CA scheme.

In an embodiment, a resource used for the CCCH resource is the same for all cells of a communication system. This way, all cellular UEs and D2D UEs in the communication system are aware of the D2D CCCH and can use the D2D CCCH as will be described in more detail. Furthermore, in an embodiment, the dedicated resource information of the D2D CCCH can be a time domain. In an alternative embodiment, the dedicated resource information of the D2D CCCH can be a frequency domain.

In an embodiment, a D2D UE registers itself with a cell that the eNB resides in order to receive the resource of the D2D CCCH. After the D2D UE registers itself, the D2D UE can receive other information from eNB. For example, the D2D UE can receive a cell-identity of the cell. As another example, the D2D UE can receive fractional power control parameters used by the cell. Furthermore, in the embodiment, the D2D UE can provide the eNB capability information about itself. For example, the D2D UE can provide the eNB with UE category information (i.e., whether the UE is a D2D UE or a cellular UE). As another example, the UE can provide the eNB with maximum transmission power information.

In an embodiment, the resource of the D2D CCCH is located in a cellular DL spectrum. This is because a cellular UE can listen to the D2D CCCH and receive D2D UE information transmitted by a centralized controller in order to determine a location of D2D UEs, as will be described below in more detail.

While the illustrated embodiment in FIG. 2 only depicts a single eNB, one of ordinary skill in the art would readily appreciate alternative embodiments where multiple eNBs perform the functionality of 200 and 210. Thus, in an alternative embodiment, multiple eNBs can each establish their own DRECH, and each broadcast a dedicated resource of a D2D CCCH.

At 220, according to the embodiment, a cellular UE determines its potential interference to D2D UEs. As previously discussed, a cellular UE can cause interference for a D2D UE engaging in a D2D communication when a cellular UE and D2D UE share UL frequency resources. In particular, a cellular UE which is near an edge of its cell can interfere with cross-cell D2D UEs located in adjoining cells.

A cellular UE can determine its potential interference to D2D UEs in a number of ways according to different embodiments. In one embodiment, a cellular UE may monitor a D2D CCCH and listen for information transmitted by a D2D UE to determine a location of the D2D UE, and to determine whether the location is sufficiently proximate to the location of the cellular UE for interference to occur. For example, a cellular UE may monitor a D2D CCCH and receive a signal transmitted by a D2D UE. The cellular UE can then determine the power level of the received signal in order to determine whether the pair of D2D UE is sufficiently near the cellular UE that the cellular UE may interfere with the D2D UE.

Monitoring the D2D CCCH can provide the cellular UE information with necessary information to locate a D2D UE, as there is constant signaling on the CCCH during D2D communication. For example, as described above, at the beginning of a D2D transmission RTS/CTS messages are exchanged via the CCCH. Furthermore, data control signaling is exchanged during D2D data transmission and acknowledgment (or non-acknowledgment) messages are sent for each transmission packet in a D2D communication. The cellular UE is able to monitor the CCCH, receive the information that the D2D UE is transmitting to the other D2D UE, and measure the received information in order to determine the location of the D2D UEs. Because the CCCH is a dedicated channel, the measurement results of the cellular UE determined from the CCCH will be reliable. In an embodiment, a cellular UE can listen to the CCCH for a defined period of time to accurately determine the location of D2D UEs.

In another embodiment, a cellular UE may directly access location information of D2D UEs, as well as the location of itself, and use the location information to identify cross-cell D2D UEs that the cellular UE can potentially interfere with. For example, an eNB may provide the location information of cellular UEs and D2D UEs within the cell of the eNB. A cellular UE can request the eNB for the location information of other cellular UEs and D2D UEs, and can use the location information to identify cross-cell D2D UEs that the cellular UE may interfere with.

In addition to determining a location of a pair of D2D UEs, a cellular UE can determine its potential interference to D2D UEs by identifying whether the cellular UE is near an edge of the cell that the cellular UE resides in. As described above, inter-cell interference (where the source of the interference for a pair of cross-cell D2D UEs is not within the cell of either the sending UE or the receiving UE) interference is very difficult to control. Thus the identification of inter-cell interference is very important. In an embodiment, the cellular UE identifies path-loss information for itself. In general, a large path-loss value means that the cellular UE is located at a very large distance from the eNB, and thus, is near the edge of its cell. In another embodiment, the cellular UE identifies power headroom information in order to determine whether the cellular UE is near an edge of the cell.

In an embodiment, while the cellular UE determines its potential interference to D2D UEs, the RxUE can determine which cellular UE can share a same resource that the RxUE can use for D2D transmission (not shown). For example, the RxUE can determine that it can share a resource with a second cellular UE (not shown), where the RxUE can use the resource for D2D transmission, and the second cellular UE can also use the resource for cellular transmission.

At 230, according to the embodiment, if the cellular UE determines that it is near a D2D UE (which means that the cellular UE may potentially interfere with the D2D transmission of the D2D UE), the cellular UE decodes its UL resource grant information and transmits the information via the DRECH previously established by the eNB, to the D2D UE. In the illustrated embodiment, the cellular UE is near both the TxUE and the RxUE, and thus, the cellular UE transmits the information via the DRECH to both the TxUE and the RxUE. The UL resource grant information includes information about one or more resources that the cellular UE will utilize for conventional cellular data transmission. With this information, a D2D can determine that by using a selected resource that is also a resource for a cellular UE, near-far interference can occur.

The UL resource grant information can include certain types of information according to different embodiments. For example, in an embodiment, the UL resource grant information can include time domain information. In other embodiment, the UL resource grant information can include a frequency domain, a code domain, and a spatial domain.

In an embodiment, the transmission power of the signal that the cellular UE transmits via the DRECH can be controlled so that a D2D UE that monitors the DRECH can judge whether the cellular UE may potentially interfere with a D2D transmission. For example, if the transmission power exceeds a pre-defined threshold, then it denotes potential interference to D2D transmission if the D2D UE uses the resources indicated in the UL resource grant information. To implement such an operation, and to give a correct interference warning on the potential interference, the transmission power of the signal that the cellular UE transmits via the DRECH can be the same as the transmission power of the signal that the cellular UE transmits during conventional cellular data transmission. Thus, by monitoring the transmission power of the signal from the cellular UE via the DRECH, the D2D UE can know the transmission power that the cellular UE will use for its conventional cellular data transmission.

While the illustrated embodiment in FIG. 2 only depicts a single cellular UE, one of ordinary skill in the art would readily appreciate alternative embodiments where multiple cellular UEs perform the functionality of 220 and 230. Thus, in an alternative embodiment, multiple cellular UEs can each determine their own potential interference to D2D UEs and provide their own UL resource grant information via the DRECH. In an embodiment where multiple cellular UEs provide their own UL resource grant information via the DRECH, the time domain, frequency domain, code domain, or spatial domain information may be used to avoid a collision.

Furthermore, in alternative embodiments where multiple cellular UEs provide their own UL resource grant information via the DRECH, DRECH resource allocation and coordination can be implemented in one of multiple approaches. As one example, identified as the “eNB approach,” an eNB can allocate one or more dedicated orthogonal resources for each cellular UE of the set of cellular UEs. According to the eNB approach, the eNB can allocate dedicated orthogonal resources for the DRECH in time domain, frequency domain, code domain, or spatial domain via signaling, assuming a orthogonal resource pool is large enough to handle number of cellular UEs. As another example, identified as the “contention-based approach,” an eNB only allocates a finite set of orthogonal resources for use by the DRECH, and the interested cellular UEs compete for the orthogonal resources of the DRECH in a contention-based manner. Specifically, each interested cellular UE attempts to reserve an orthogonal resource when needed, and when all orthogonal resources are already reserved, the cellular UE must “back off” and attempt its reservation after a specific wait time.

To reduce the requirements for orthogonal resources in the eNB approach, the eNB does not need to allocate a dedicated orthogonal resource for each cellular UE of the set of cellular UEs. Instead, the eNB can identify a subset of cellular UEs within the original set of cellular UEs, and merely allocate dedicated orthogonal resources for each cellular UE within the subset, rather than the original sent.

In the eNB approach, the eNB can identify a subset of cellular UEs in one of multiple methods. As one example, the eNB can merely allocate dedicated orthogonal resources for a subset of cellular UEs that are identified as potential interferers to D2D transmission. In this method, if a cellular UE is identified as a cellular UE that may potentially interfere with D2D transmission, then the cellular UE is allocated a dedicated orthogonal resource. In contrast, if the cellular UE cannot potentially interfere with D2D transmission then the cellular UE is not allocated a dedicated orthogonal resource. According to this method, the cellular UE may identify itself to the eNB as a potential interferer by monitoring a D2D CCCH, listening for information transmitted by a pair of D2D UEs, and determining whether the location of one or both of the D2D UEs is sufficiently proximate to the location of the cellular UE for interference to occur, as described above. Furthermore, according to this method, the cellular UE only conveys its own physical downlink control channel (PDCCH) to the eNB in order for the eNB to allocate a resource in the DRECH.

As another example of identifying a subset of cellular UEs, according to the eNB approach, the eNB identifies the subset of cellular UEs that are near an edge of their respective cell, and designates them as “relaying cellular UEs.” The eNB then allocates orthogonal resources for only the relaying cellular UEs. Subsequently, each relaying UE can listen for information by a “non-relaying cellular UE” and forward the non-relaying cellular UE's information (including the non-relaying cellular UE's PDCCH via the DRECH. According to this method, the relaying cellular UE can relay several cellular UE's information (including PDCCH information) rather than its own information.

At 240, according to the embodiment, the RxUE selects a D2D resource. In selecting a resource, according to the embodiment, the RxUE uses the UL resource grant information transmitted by the cellular UE in order to select the D2D resource that avoids potential near-far interference from a cellular UE. For example, if the transmission power of the signal carrying the UL resource grant information received from the cellular UE via the DRECH is greater than a pre-determined threshold, the RxUE can determine that the resource associated with the cellular UE should not be used, because the cellular UE can potentially interfere with D2D transmission. Thus, the RxUE can select a resource for D2D transmission that is different from the resource associated with the cellular UE.

In an embodiment, the RxUE can combine the UL resource grant information transmitted by the cellular UE with RxUE's own interference measurements in order to select a D2D resource. For example, the RxUE can receive information regarding UL resource allocation information for cellular UEs within its own cell from the eNB (not shown). In one embodiment, the RxUE can receive UL radio resource management (RRM) information for all cellular UEs within the RxUE's cell from the eNB and decode the UL RRM information to obtain the UL resource allocation information. The RxUE can then measure the interference caused by all cellular UEs within the RxUE's cell for a defined period of time. This way, the RxUE can use its own interference measurements for cellular UEs within its own cell, as well as the interference measurements received via the DRECH for cellular UEs in neighboring cell to select a resource for D2D transmission and avoid near-far interference.

In an embodiment, the RxUE may not receive any resource allocation via the DRECH. This means that there is no interference to D2D transmission from the other cells. In this embodiment, the RxUE can select a D2D resource by only using its own interference measurements from within its own cell as described above.

While the illustrated embodiment in FIG. 2 depicts the RxUE selecting a D2D resource, one of ordinary skill in the art would readily appreciate that in an alternative embodiment, the TxUE can select the D2D resource.

At 250, according to the embodiment, the RxUE transmits the selected D2D resource to a TxUE. In an embodiment, the RxUE transmits the selected D2D resource to the TxUE via the CCCH. While the illustrated embodiment in FIG. 2 depicts the RxUE transmitting the selected D2D resource, one of ordinary skill in the art would readily appreciate that in an alternative embodiment, the TxUE can transmit the selected D2D resource.

At 260, according to the embodiment, the TxUE initiates a D2D data transmission with the RxUE using the selected D2D resource. By utilizing the method described above, the pair of D2D UEs can avoid both types of near-far interference: intra-cell interference and inter-cell interference.

While the illustrated embodiment in FIG. 2 only depicts a single TxUE and a single RxUE, one of ordinary skill in the art would readily appreciate alternative embodiments where multiple TxUEs or multiple RxUEs can perform the functionality of 240, 250, and 260.

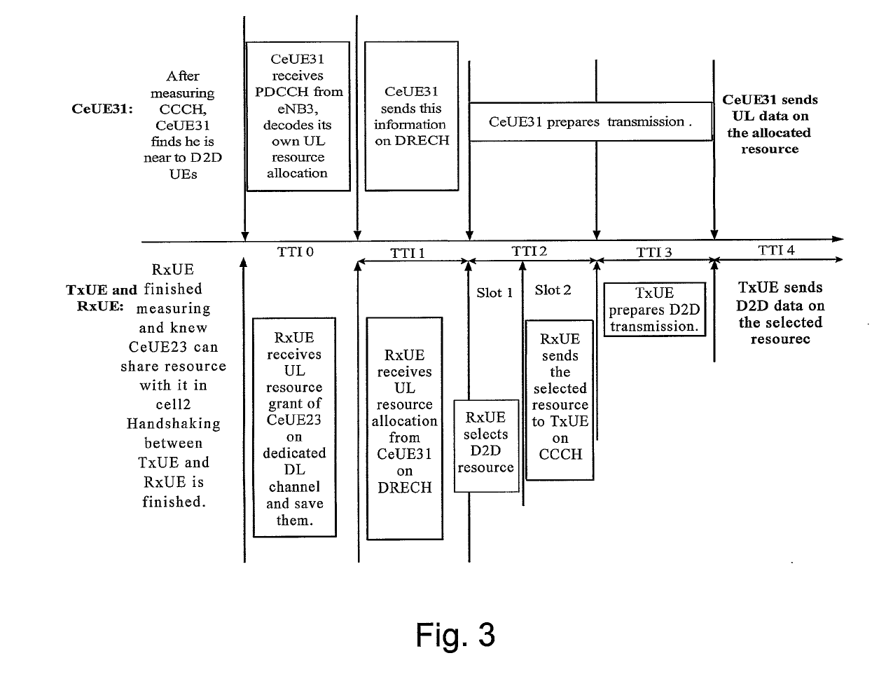

FIG. 3 illustrates a timing diagram for a method of control sensing and device-to-device resource coordination according to one embodiment. The illustrated embodiment pertains to system 100 of FIG. 1, and the system components described in relation to FIG. 1. In particular, the illustrated embodiment pertains to CeUE31 (a cellular UE), and TxUE and RxUE (D2D UEs) of FIG. 1. FIG. 3 indicates the functionality performed by CeUE31, RxUE, and TxUE at different time intervals according to the embodiment.

Before transmit time interval (TTI) 0, CeUE31 measures a D2D CCCH, as described above, and determines that it is near to a pair of D2D UEs (i.e., RxUE and TxUE), and thus, may potentially interfere with D2D communication between RxUE and TxUE. Also before TTI 0, RxUE measures and determines that CeUE23 is capable of sharing resources in cell 2 as described above. Furthermore, before TTI 0, TxUE and RxUE have finished performing the RTS/CTS handshaking procedure via the D2D CCCH as described above.

At TTI 0, CeUE31 receives a PDCCH from eNB3 and decodes its own UL resource grant information. Thus, CeUE31 knows resource information necessary for cellular communication. Also at TTI 0, RxUE receives UL resource grant information of CeUE23 on a dedicated DL channel and saves the resource grant information. Thus, RxUE knows resource information necessary for D2D communication, where the resource can also be used by CeUE23 for cellular communication.

At TTI 1, CeUE31 sends its UL resource grant information to both TxUE and RxUE via a DRECH, that has previously been defined by eNB3. This is after CeUE31 determines that it is a potential interferer to a pair of D2D UEs. Also at TTI 1, RxUE receives the UL resource grant allocation sent by CeUE31 via the DRECH. With the UL resource grant allocation from CeUE31, RxUE can determine whether it can share the resource with CeUE31, or whether CeUE31 will interfere with the D2D communication of RxUE.

At TTI 2, CeUE31 prepares its cellular data transmission. CeUE31 prepares its transmission throughout TTI 2 and TTI 3. During this time, a D2D UE can have the opportunity to determine whether CeUE31 is a potential interferer, as will be discussed below in more detail. At TTI 4, CeUE31 sends its UL data via an allocated resource to eNB3, and eventually to another cellular UE.

With respect to TxUE and RxUE, at slot 1 of TTI 2, RxUE selects a D2D resource. This selection is based on the received UL resource allocation from CeUE31 via the DRECH, and its own measurement results within its cell. If RxUE determines that CeUE31 will likely interfere with its D2D communication, based on the received UL resource allocation, RxUE will avoid selecting the resource used by CeUE31. At slot 2 of TTI 2, RxUE sends the selected resource to TxUE via the CCCH. At TTI 3, TxUE prepares its D2D data transmission. At TTI 4, TxUE sends its D2D data via the selected resource.

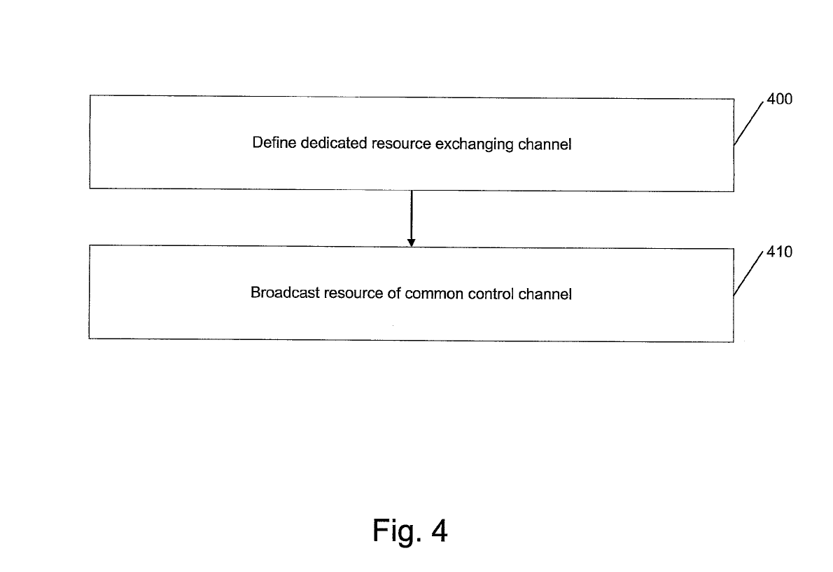

FIG. 4 illustrates a flow diagram of a method according to one embodiment. At step 400, a dedicated resource exchanging channel is defined. The dedicated resource exchanging channel can be used to relay resource information used to perform interference sensing. For example, the dedicated resource exchanging channel can be used by a cellular UE to transmit UL resource grant information to a D2D UE. The transmission power of the transmitted UL resource grant information can be controlled so that it matches the transmission power of UL data transmission. Thus, a D2D UE can use the transmitted UL resource grant information in order to determine whether the cellular UE potentially interferes with the D2D UE.

The defining of the dedicated resource exchanging channel can include assigning one or more dedicated resources for the dedicated resource exchanging channel. The one or more dedicated resources can include a time domain, a frequency domain, a code domain, or any combination of the domains. The one or more dedicated resources can be located in a cellular uplink spectrum.

At step 410, a resource of a common control channel is broadcasted. The common control channel can be broadcast to all UEs within a given cell. The common control channel can be utilized by a pair of D2D UEs in order to handshaking procedure. The handshaking procedure can be a CSMA/CA handshaking procedure. Examples of a resource can be a time domain, a frequency domain, or a code domain.

The common control channel can be the same for all cells. The common control channel can be located in a cellular downlink spectrum. In an embodiment, steps 400 and 410 can be performed by a centralized controller. In a specific embodiment, the centralized controller can be an eNB.

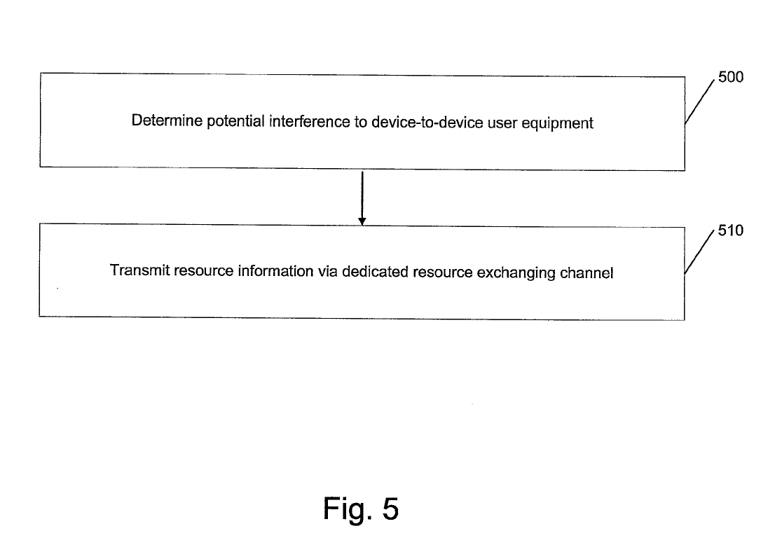

FIG. 5 illustrates a flow diagram of a method according to another embodiment. At step 500, a potential interference to a D2D UE is determined. A potential interference to a D2D UE can be determined in a number of ways according to different embodiments. In one embodiment, determining a potential interference comprises monitoring a D2D CCCH and listening for information transmitted by D2D UE to determine a location of the D2D UE, and to determine whether the location is sufficiently proximate for interference to occur. In another embodiment, determining a potential interference comprises directly accessing location information of a D2D UE, and using the location information to identify a D2D UE that can potentially be interfered with.

In an embodiment, step 500, as well as step 510, can be performed at a cellular UE. In this embodiment, determining a potential interference can additionally comprise determining the location of the cellular UE. In an alternative embodiment, determining a potential interference can additionally comprise by identifying whether the cellular UE is near an edge of a cell that the cellular UE resides in.

At step 510, resource information is transmitted via a dedicated resource exchange channel. The resource information can be used to perform interference sensing. The resource information can be transmitted to a D2D UE. The resource information can include one or more resources that a cellular UE can utilize for cellular data transmission. The one or more resources can include a time domain, a frequency domain, a code domain, a spatial domain, or a combination of such domains. A signal that the resource information is transmitted in can have the same transmission power as a signal used by a cellular UE for cellular data transmission.

In an embodiment where step 510 is performed at a cellular UE, transmitting resource information can include transmitting a physical downlink control channel of the cellular UE. In an alternative embodiment where step 510 is performed at a cellular UE, transmitting resource information can include transmitting a physical downlink control channel of one or more other cellular UEs.

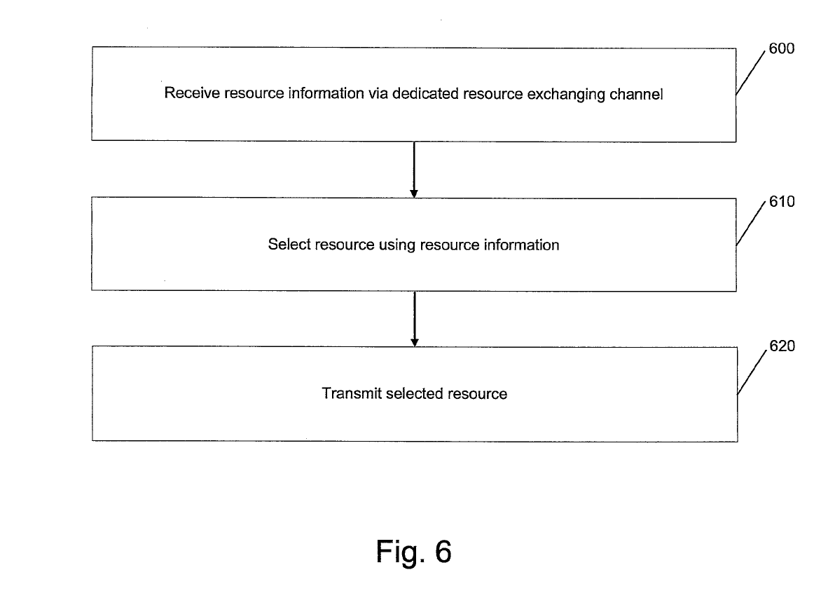

FIG. 6 illustrates a flow diagram of a method according to another embodiment. At step 600, resource information is received via a dedicated resource exchange channel. The resource information can be used to perform interference sensing. The resource information can include one or more resources that a cellular UE can utilize for cellular data transmission. The one or more resources can include a time domain, a frequency domain, a code domain, a spatial domain, or a combination of such domains.

At 610, a resource is selected using the received resource information. The selection of a resource can utilize the received resource information in order to select a resource that avoids potential interference from a cellular UE. For example, if the transmission power of a signal carrying the received resource information is greater than a pre-determined threshold, a different resource can be selected to avoid potential interference.

At 620, the selected resource is transmitted. In an embodiment, the selected resource can be transmitted from a first D2D UE to a second D2D UE. Also in the embodiment, the second D2D UE can initiate D2D transmission via the selected resource. In an embodiment, steps 600, 610, and 620 can be performed by a D2D UE.

The steps of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components.

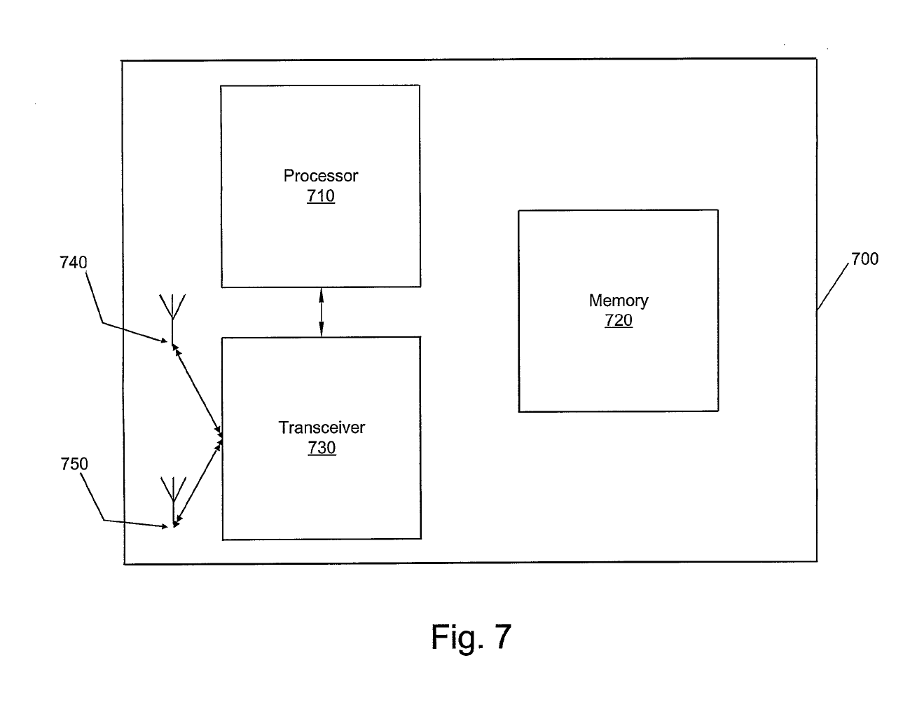

FIG. 7 illustrates a block diagram of an apparatus 700 according to one embodiment. Apparatus 700 can include a processor 710 and a memory 720. Processor 710 can read information from, and write information to, memory 720. Processor 710 can be a front end processor, a back end processor, a microprocessor, a digital signal processor, a processor with an accompanying digital signal processor, a special-purpose computer chip, a field-programmable gate array (FPGA), a controller, an ASIC, or a computer. Memory 720 can be RAM, flash memory, ROM, EPROM, EEPROM, registers, hard disk, a removable disk, a CD-ROM, or any other form of storage medium known in the art. Memory 720 can include computer program code. As one of ordinary skill in the art would readily appreciate, apparatus 700 can include any number of processors in alternative embodiments. Likewise, apparatus 700 can include any number of memories in alternative embodiments.

Apparatus 700 can also include a transceiver 730, which is configured to send and receive a signal, and which is connected to processor 710. Apparatus 700 can also include antennas 740 and 750, where each antenna is configured to assist transceiver 730 in the sending and receiving of a signal. While the illustrated embodiment in FIG. 7 depicts two antennas, one of ordinary skill in the art would readily appreciate that apparatus 700 can include any number of antennas in alternative embodiments. In an alternative embodiment, apparatus 700 can include a single antenna.

Processor 710 and memory 720 can cause apparatus 700 to a define a dedicated resource exchanging channel. The dedicated resource exchanging channel can be used to relay resource information used to perform interference sensing. For example, the dedicated resource exchanging channel can be used by a cellular UE to transmit UL resource grant information to a D2D UE. The transmission power of the transmitted UL resource grant information can be controlled so that it matches the transmission power of UL data transmission. Thus, a D2D UE can use the transmitted UL resource grant information in order to determine whether the cellular UE potentially interferes with the D2D UE.

In defining of the dedicated resource exchanging channel, processor 710 and memory 720 can cause the apparatus to assign one or more dedicated resources for the dedicated resource exchanging channel. The one or more dedicated resources can include a time domain, a frequency domain, a code domain, or any combination of the domains. The one or more dedicated resources can be located in a cellular uplink spectrum.

Processor 710 and memory 720 can also cause apparatus 700 to broadcast a resource of a common control channel. Apparatus 700 can broadcast the common control channel to all UEs within a given cell. The common control channel can be utilized by a pair of D2D UEs in order to handshaking procedure. The handshaking procedure can be a CSMA/CA handshaking procedure. Examples of a resource can be a time domain, a frequency domain, or a code domain.

The common control channel can be the same for all cells. The common control channel can be located in a cellular downlink spectrum. In an embodiment, apparatus 700 can be a centralized controller. In a specific embodiment, apparatus 700 can be an eNB.

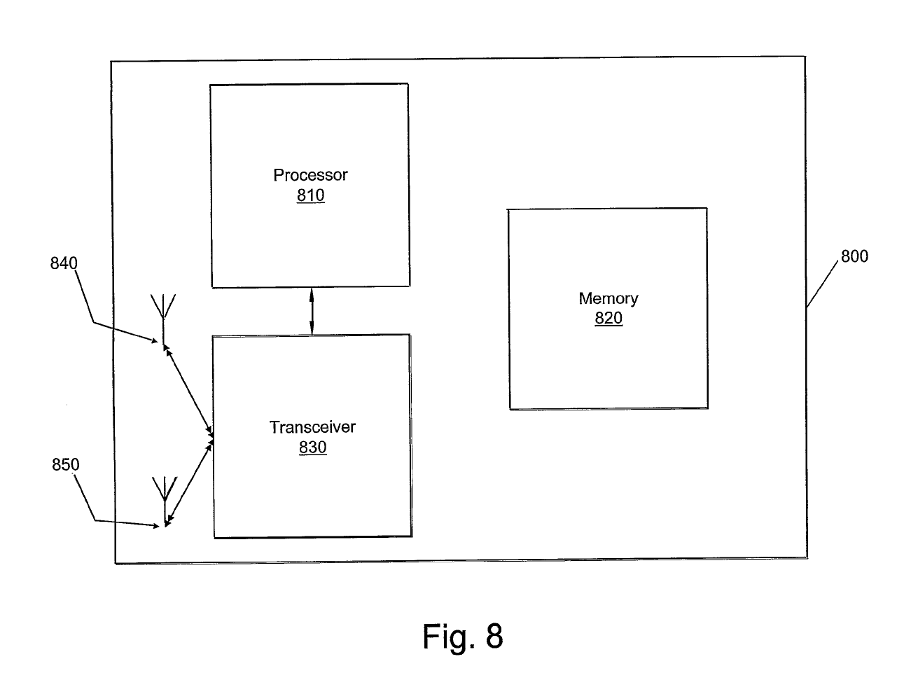

FIG. 8 illustrates a block diagram of an apparatus 800 according to another embodiment. Apparatus 800 can include a processor 810 and a memory 820. Processor 810 can read information from, and write information to, memory 820. Processor 810 can be a front end processor, a back end processor, a microprocessor, a digital signal processor, a processor with an accompanying digital signal processor, a special-purpose computer chip, a FPGA, a controller, an ASIC, or a computer. Memory 820 can be RAM, flash memory, ROM, EPROM, EEPROM, registers, hard disk, a removable disk, a CD-ROM, or any other form of storage medium known in the art. Memory 820 can include computer program code. As one of ordinary skill in the art would readily appreciate, apparatus 800 can include any number of processors in alternative embodiments. Likewise, apparatus 800 can include any number of memories in alternative embodiments.

Apparatus 800 can also include a transceiver 830, which is configured to send and receive a signal, and which is connected to processor 810. Apparatus 800 can also include antennas 840 and 850, where each antenna is configured to assist transceiver 830 in the sending and receiving of a signal. While the illustrated embodiment in FIG. 8 depicts two antennas, one of ordinary skill in the art would readily appreciate that apparatus 800 can include any number of antennas in alternative embodiments. In an alternative embodiment, apparatus 800 can include a single antenna.

Processor 810 and memory 820 can cause apparatus 800 to determine a potential interference to a D2D UE. Apparatus 800 can determine a potential interference to a D2D UE in a number of ways according to different embodiments. In one embodiment, apparatus 800 can determine a potential interference by monitoring a D2D CCCH and listening for information transmitted by D2D UE to determine a location of the D2D UE, and determining whether the location is sufficiently proximate for interference to occur. In another embodiment, apparatus 800 can determine a potential interference by directly accessing location information of a D2D UE, and using the location information to identify a D2D UE that can potentially be interfered with.

In an embodiment, apparatus 800 can determine a potential interference by additionally determining the location of apparatus 800. In an alternative embodiment, apparatus 800 can determine a potential interference by additionally identifying whether the apparatus 800 is near an edge of a cell that apparatus 800 resides in.

Processor 810 and memory 820 can also cause apparatus 800 to transmit resource information via a dedicated resource exchange channel. The resource information can be used to perform interference sensing. Apparatus 800 can transmit resource information to a D2D UE. The resource information can include one or more resources that a cellular UE can utilize for cellular data transmission. The one or more resources can include a time domain, a frequency domain, a code domain, a spatial domain, or a combination of such domains. A signal that the apparatus 800 transmits the resource information in can have the same transmission power as a signal used by a cellular UE for cellular data transmission. In an embodiment, apparatus 800 can be a cellular UE.

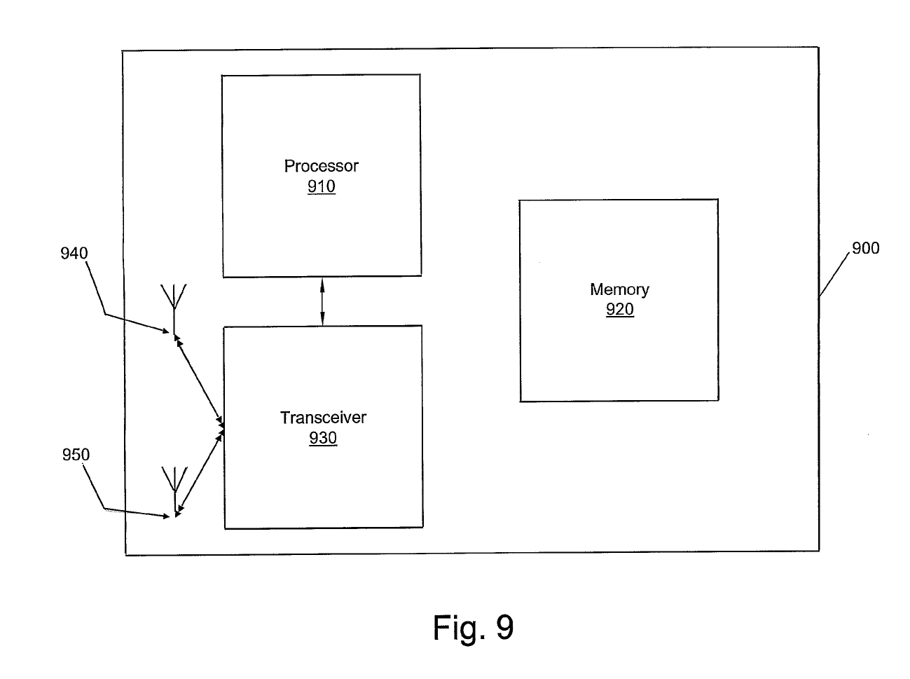

FIG. 9 illustrates a block diagram of an apparatus 900 according to another embodiment. Apparatus 900 can include a processor 910 and a memory 920. Processor 910 can read information from, and write information to, memory 920. Processor 910 can be a front end processor, a back end processor, a microprocessor, a digital signal processor, a processor with an accompanying digital signal processor, a special-purpose computer chip, a FPGA, a controller, an ASIC, or a computer. Memory 920 can be RAM, flash memory, ROM, EPROM, EEPROM, registers, hard disk, a removable disk, a CD-ROM, or any other form of storage medium known in the art. Memory 920 can include computer program code. As one of ordinary skill in the art would readily appreciate, apparatus 900 can include any number of processors in alternative embodiments. Likewise, apparatus 900 can include any number of memories in alternative embodiments.

Apparatus 900 can also include a transceiver 930, which is configured to send and receive a signal, and which is connected to processor 910. Apparatus 900 can also include antennas 940 and 950, where each antenna is configured to assist transceiver 930 in the sending and receiving of a signal. While the illustrated embodiment in FIG. 9 depicts two antennas, one of ordinary skill in the art would readily appreciate that apparatus 900 can include any number of antennas in alternative embodiments. In an alternative embodiment, apparatus 900 can include a single antenna.

Processor 910 and memory 920 can cause apparatus 900 to receive resource information via a dedicated resource exchange channel. The resource information can be used to perform interference sensing. The resource information can include one or more resources that a cellular UE can utilize for cellular data transmission. The one or more resources can include a time domain, a frequency domain, a code domain, a spatial domain, or a combination of such domains.

Processor 910 and memory 920 can also cause apparatus 900 to select a resource using the received resource information. In selecting a resource, apparatus 900 can utilize the received resource information in order to select a resource that avoids potential interference from a cellular UE. For example, if the transmission power of a signal carrying the received resource information is greater than a pre-determined threshold, apparatus 900 can select a different resource to avoid potential interference.

Processor 910 and memory 920 can also cause apparatus 900 to transmit the selected resource. In an embodiment, the selected resource can be transmitted to a D2D UE. Also in the embodiment, the D2D UE can initiate D2D transmission via the selected resource. In an embodiment, apparatus 900 can be a D2D UE.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-35. (canceled)

36. A method, comprising:
determining a potential interference to a device-to-device user equipment; and
transmitting resource information over a dedicated resource exchanging channel to the device-to-device user equipment if said potential interference is determined,
wherein the transmission of the resource information is adapted to be usable by said device-to-device user equipment to perform interference sensing.

37. The method of claim 36, wherein the determining the potential interference comprises monitoring a device-to-device common control channel and listening for information transmitted by a device-to-device user equipment on said device-to-device common control channel to determine a location of the device-to-device user equipment, and
wherein the determining the potential interference comprises determining whether the location of the device-to-device user equipment is sufficiently proximate for interference to occur.

38. The method of claim 36, wherein the determining the potential interference comprises directly accessing location information of a device-to-device user equipment, and
wherein the determining the potential interference comprises determining whether the location of the device-to-device user equipment is sufficiently proximate for interference to occur.

39. The method of claim 36, wherein the resource information comprises one or more resources that a cellular user equipment utilizes for cellular data transmission.

40. The method of claim 36, wherein the transmission of the resource information is adapted to be usable by said device-to-device user equipment to perform interference sensing by adapting a transmission power of the transmission of the resource information to be the same as a transmission power used for cellular data transmission.

41. The method of claim 36, wherein the determining and transmitting is performed at a cellular user equipment.

42. The method of claim 41, wherein the determining the potential interference comprises determining the location of the cellular user equipment.

43. The method of claim 42, wherein the determining the location of the cellular user equipment comprises identifying whether the cellular user equipment is near an edge of a cell that the cellular user equipment resides in.

44. The method of claim 41, wherein transmitting the resource information comprises transmitting a physical downlink control channel of the cellular user equipment.

45. The method of claim 41, wherein transmitting resource information comprises transmitting a physical downlink control channel of one or more other cellular user equipments.

46. An apparatus, comprising:
a processor; and
a memory comprising computer program code,
the memory and the computer program code configured to, with the processor, cause the apparatus to
determine a potential interference to a device-to-device user equipment, and
transmit resource information over a dedicated resource exchanging channel to the device-to-device user equipment if said potential interference is determined; and
adapt the transmission of the resource information to be usable by said device-to-device user equipment to perform interference sensing.

47. The apparatus of claim 46, wherein the memory and the computer program code configured to, with the processor, cause the apparatus to,
monitor a device-to-device common control channel and listen for information transmitted by a device-to-device user equipment on said device-to-device common control channel to determine a location of the device-to-device user equipment, and
determine whether the location of the device-to-device user equipment is sufficiently proximate for interference to occur.

48. The apparatus of claim 46, wherein the memory and the computer program code configured to, with the processor, cause the apparatus to,
directly access location information of a device-to-device user equipment, and
determine whether the location of the device-to-device user equipment is sufficiently proximate for interference to occur.

49. The apparatus of claim 46, wherein the memory and the computer program code configured to, with the processor, cause the apparatus to
adapt a transmission power of the transmission of the resource information to be the same as a transmission power used for cellular data transmission.

50. The apparatus of claim 46, wherein the apparatus is a cellular user equipment.

51. An apparatus, comprising:
a processor; and
a memory comprising computer program code,
the memory and the computer program code configured to, with the processor, cause the apparatus to
receive resource information over a dedicated resource exchange channel;
perform interference sensing using a signal comprising the resource information to determine a potential interference;
select a resource using the received resource information in dependence of the determined potential interference; and
transmit a device-to-device signal using the selected resource.

52. The apparatus of claim 51, wherein the memory and the computer program code configured to, with the processor, cause the apparatus to,
perform interference sensing comprising determining a received transmission power of the signal comprising the resource information, and
determine a potential interference comprising determining whether the received transmission power exceeds a threshold.

53. The apparatus of claim 51, wherein the memory and the computer program code configured to, with the processor, cause the apparatus to utilize the received resource information to select a resource that avoids potential interference.

54. The apparatus of claim 51, wherein the apparatus is a device-to-device user equipment.

55. The apparatus of claim 51, wherein the resource information is received from a cellular user equipment.
